(19) United States
(12) Patent Application Publication
(10) Pub. No.: US 2001/0001687 A1
(43) Pub. Date: May 24, 2001

(54) FIBER-REINFORCED VEHICLE INTERIOR TRIM AND METHOD OF MANUFACTURE

(76) Inventors: TONY M. POKORZYNSKI, HOLLAND, MI (US); TIMOTHY J. THEISEN, HOLLAND, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 09/074,288

(22) Filed: May 7, 1998

(51) Int. Cl. B32B 5/18; B29C 65/00

(52) U.S. Cl. 428/318.6; 428/318.8; 428/319.1; 428/309.9; 422/221; 264/46.5

(57) ABSTRACT

Fiber-reinforced vehicle interior trim and a method of manufacturing interior trim in a one-step molding process. A skin material and fibrous reinforcement mat are located in a molding tool. A moldable foam-forming material is applied to the tool between the skin material and the fibrous reinforcement mat. The foam-forming material penetrates the mat and expands and cures such that the foam binds to both the skin and the reinforcement mat to produce a molded interior trim piece.

### BACKGROUND OF THE INVENTION

The present invention generally relates to interior trim for a motor vehicle and, more particularly, to an automotive vehicle fiber-reinforced interior trim and a method of manufacture.

Interior trim is commonly found on automotive vehicle headliners, door panels, instrument panels, center consoles, as well as various other interior trim components in an vehicle such as an automobile. Typical vehicle interior trim contains a protective outer skin layer, such as a polyvinyl chloride (PVC), a rigid structural substrate on the back, and a soft urethane foam interstitial layer disposed therebetween. Conventional vehicle interior trim is generally manufactured in a multiple-step process whereby the structural substrate is molded in a first die. The molded structural substrate is then typically adhesively attached to a foam material having an outer trim layer, such as a PVC skin. As a consequence, conventional methods of interior trim manufacture require the steps of separately molding the structural substrate and then the subsequently attaching the substrate to the foam. In addition, conventional approaches are often susceptible to creating defects in the interior trim material, such as voids which can result in sheer collapse of the trim material.

It is, therefore, one object of the present invention to provide for a method of manufacturing vehicle interior trim having both a cushioning material and a reinforcement backing. More particularly, it is an object of the present invention to provide a method of manufacturing such vehicle interior trim with reduced manufacturing steps. It is also an object of the present invention to achieve vehicle interior trim manufacture with an enhanced foaming operation that, in contrast to conventional approaches, is less susceptible to creating defects in the final trim product. In one aspect of the invention, the resulting trim piece has a porous substrate through which the foam extends.

### SUMMARY OF THE INVENTION

The interior trim and method of the present invention satisfies these needs by providing the manufacture of vehicle interior trim having an outer trim layer, a reinforcement back layer, and an intermediate foam layer that bonds to the trim layer and the reinforcement layer. The method includes the steps of locating a skin material and a fibrous reinforcement mat in a molding tool. A moldable foam-forming material is applied to the molding tool between the skin material and the fibrous reinforcement mat. The foam-forming material penetrates openings in the reinforcement mat and expands and cures such that the foam binds to both the skin and the reinforcement mat. Once cured, the interior trim is removed from the molding tool. Accordingly, the present invention provides for a method of manufacturing interior trim in a one-step molding process.

According to one embodiment, the skin material is located on one die part of a foam molding tool and the fibrous reinforcement mat is placed on a second die part of the foam molding tool. The moldable, foam-forming material is applied between the skin material and the fibrous reinforcement mat, and the tool is closed and the foam-forming material is allowed to expand and cure so that the foam-forming material binds to the skin and the reinforcement mat.

According to a second embodiment, the skin material is placed in the molding tool and the fibrous reinforcement mat is placed on top of a portion of the skin material, while portions of the fibrous reinforcement mat are separated from the skin material. The moldable foam-forming material is applied to the molding tool and penetrates through the reinforcement mat and between the skin material and the reinforcement mat. The tool is closed and the foam-forming material is allowed to expand and to cure so that the foam-forming material binds to the skin material and the reinforcement mat.

These and other features, objects, and advantages of the present invention will become apparent upon reading the following description thereof, together with reference to the accompanying drawings.

### BRIEF DESCRIPTION OF THE DRAWINGS

In the drawings:

FIG. 1 is a fragmentary cross-sectional view of an interior trim of the present invention for use in a vehicle and which is also manufactured according to the method of the present invention;

FIG. 2 is a flow diagram illustrating the method of manufacturing the vehicle interior trim panel according to one embodiment of the present invention;

FIG. 3 is a perspective schematic view of a two-part molding tool illustrating the manufacture of vehicle interior trim panel according to the method of FIG. 2;

FIG. 4 is a perspective schematic view of the two-part molding tool further illustrating the manufacture of vehicle interior trim panel;

FIG. 5 is a flow diagram illustrating the method of manufacturing a vehicle interior trim panel according to another embodiment of the present invention;

FIG. 6 is a perspective schematic view of the two-part molding tool illustrating the manufacture of vehicle interior trim panel according to the method of FIG. 5; and

FIG. 7 is a fragmentary cross-sectional view of another piece of interior trim manufactured according to the alternative embodiment of the present invention.

### DETAILED DESCRIPTION OF THE PREFERRED EMBODIMENTS

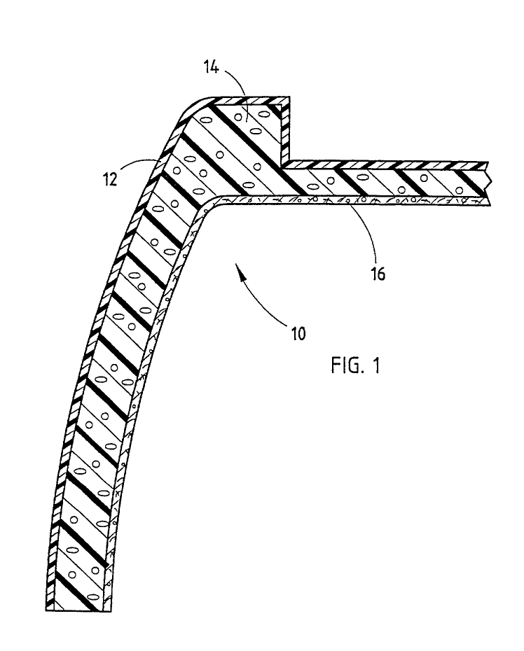

Referring to FIG. 1, there is shown a cross-sectional view of an interior trim panel 10 for use in a vehicle. Panel 10 may be a door panel, a headliner, a console, part of the instrument panel, or other interior trim member. Panel 10 is also manufactured in accordance with the method of the present invention. Interior trim panel 10 has on its outer side a protective and decorative outer skin 12 which may be a slush molded polyvinyl chloride (PVC) skin, vinyl, leather, or other suitable outer trim material. Skin 12 is bonded to a reinforcement substrate 16 by a semi-rigid polyurethane foam 14. The inner side of interior trim panel 10 is then reinforced by the substrate which can be a fibrous reinforcement mat 16 also bonded to the semi-rigid polyurethane foam 14. The foam layer 14 advantageously provides cushioning to interior trim panel 10 and further acts as a structural binder to bind together the outer skin 12 and the fibrous reinforcement mat 16. It should be appreciated that the interior trim panel 10 as provided herein according to the present invention may be manufactured in various sizes and shapes and employed in connection with various interior trim products commonly found in an automotive vehicle.

The interior trim 10 employs the semi-rigid polyurethane foam 14 as a cushioning material as well as for a structural binding agent to bind to both the outer skin 12 and fibrous reinforcement mat 16 in a one-step molding process described below. The fibrous reinforcement mat 16 preferably includes a porous fiberglass mat or other porous fiber-based mat made of natural fibers. Prior to molding, the fibrous reinforcement mat 16 is a soft mat of fibers that can easily be reconfigured to the shape of a mold, and can further be set in a preformed configuration. The mat fibers may be in a randomly overlapping arrangement and may be woven or non-woven. The reinforcement mat 16 is porous in that it has openings provided between some of the fibers through which liquid foam-forming material may pass and also may adhere thereto as a fiberglass bonding agent. The reinforcement mat 16 may include a fiberglass mat with a density of one ounce per square foot with a porosity suitable to allow liquid foam-forming material to penetrate through the mat 16. The fibrous reinforcement mat 16 is bonded in place by the foam and provides structural reinforcement behind the cushioning of foam layer 14. By varying the thickness of foam layer 14, the cushioning provided by foam layer 14 likewise varies.

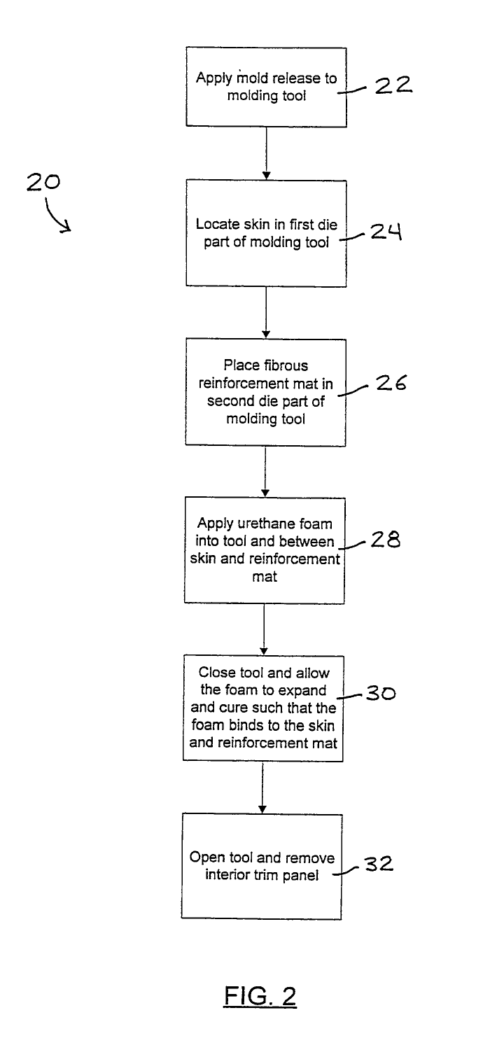

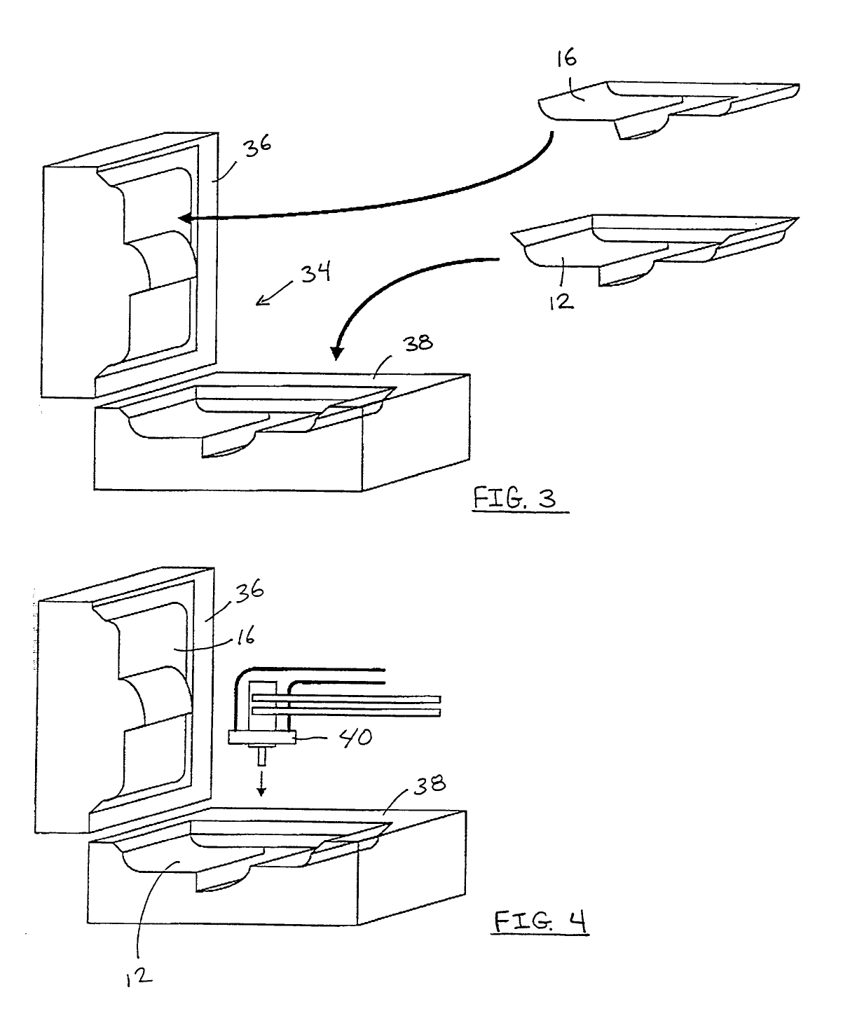

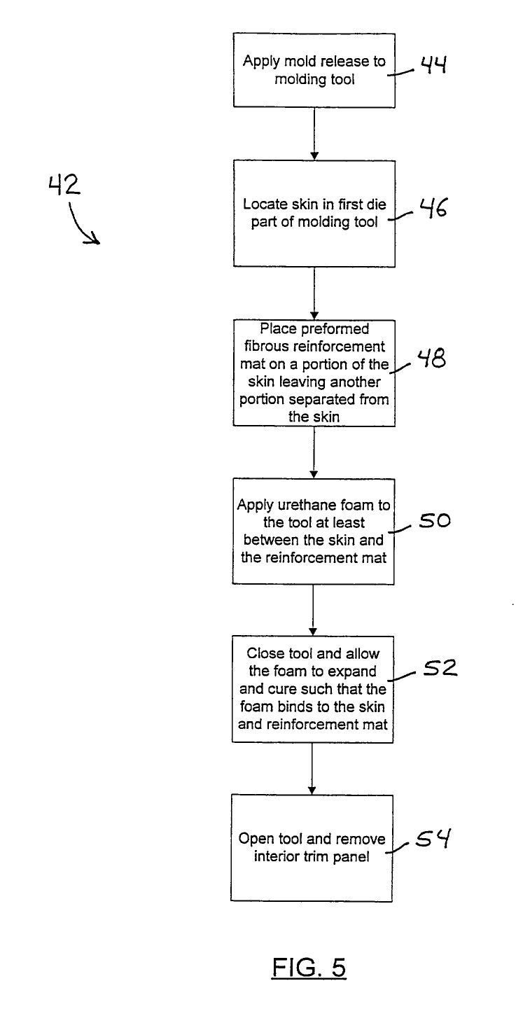

Referring to FIG. 2, a method 20 is illustrated for manufacturing vehicle interior trim 10 according to a first embodiment of the present invention. The method 20 of manufacturing interior trim preferably employs a two-part foam molding tool, such as the tool 34 shown in FIGS. 3 and 4. The foam molding tool 34 has an upper die 36 and a lower die 38 which, when closed together, provide an encapsulated mold cavity configured with a size and shape of a final trim product to be manufactured therewith. The method 20 of trim manufacture begins with step 22 of applying a mold release agent to the surface of top and bottom dies 36 and 38 of foam molding tool 34. A suitable mold release agent may include a spray on wax or other suitable release agents which aide in release of the molded trim part from the tool.

Trim manufacturing method 20 includes step 24 of locating a skin material, such as slush molded polyvinyl chloride skin 12, in the lower die 38 of foam molding tool 34. Method 20 also includes step 26 of locating the fibrous reinforcement mat 16 in the upper die 36 of foam molding tool 34 such that reinforcement mat 16 is held to the back side of the molded trim piece. The assembly of skin 12 and reinforcement mat 16 into molding tool 34 via steps 24 and 26 is illustrated in FIG. 3. It should be appreciated that skin 12 and reinforcement mat 16 could otherwise be positioned in the molding tool 34 such that skin 12 is located in the upper die 36 and reinforcement mat 16 is located in the lower die 38.

Referring to FIG. 2, trim manufacture method 20 further includes step 28 of injecting a urethane foam into the opened foam molding tool 34 between the skin 12 and reinforcement mat 16. The application of urethane foam into molding tool 34 is illustrated in FIG. 4 in which the urethane foam is applied with a pump style, high pressure foam dispenser 40 which pours a liquid urethane foam directly on top of the skin 12 located in the lower die 38. The application of liquid urethane foam may include a soft reaction-injection molding (RIM) delivery technique in which a foam-in-place (FIP) urethane foam is injected into the molding tool where it expands and is reaction cured. The foam injection equipment including dispenser 40 can be of conventional design.

Immediately following the foam injection step 28, trim manufacture method 20 includes step 30 of closing the foam molding tool 34 such that the upper die part 36 closes onto the lower die part 38 to define a mold cavity having a configuration with a size and shape of a desired final trim piece. The liquid reaction-injected moldable foam expands and penetrates into and through openings in the porous fibrous reinforcement mat 16. The foam molding tool 34 is closed sufficiently long enough to allow the urethane foam to expand to consume the open volume within the cavity of the molding tool and to cure such that the foam binds to both the skin 12 and the reinforcement mat 16. The liquid foam advantageously penetrates into the openings in the porous reinforcement mat 16 where the foam cures in place to form a foam-in-place bond. The curing step 30 preferably occurs at a temperature in the range of 90° to 150° F., for a time period in the range of 30 to 120 seconds. The time period for curing may vary depending on the foam formulation as well as the thickness of the foam and process temperature. Once the molded interior trim panel is fully cured, the foam molding tool 34 is opened and the molded interior trim panel is removed from the tool 34 pursuant to step 32. The molded trim panel can subsequently be edge trimmed, as needed.

It should be appreciated that the trim manufacturing method 20 of the present invention produces an interior trim panel with a soft foam cushioning layer and an integrally formed reinforcement layer on the back side via a one-step molding process. The fibrous reinforcement mat 16 is bonded in place to the foam such that reinforcement mat 16 provides structural rigidity to the resultant integral trim panel.

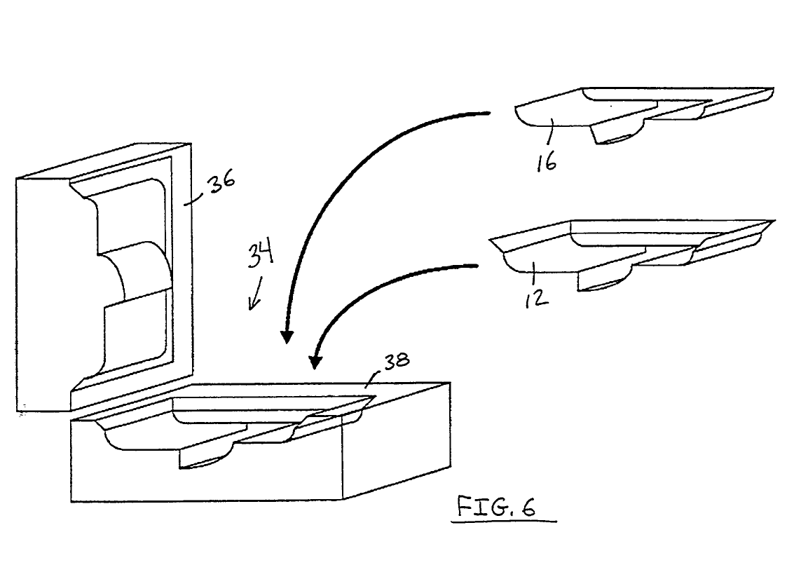

Referring to FIG. 5, a second method 42 of manufacturing vehicle interior trim according to the present invention is illustrated therein. The second trim manufacture method 42 similarly includes step 44 of applying a mold release agent to the two-die foam molding tool 34 and step 46 of locating an outer skin, such as a PVC skin 12, in the lower die 38 of the foam molding tool 34. However, in contrast to method 20, trim manufacturing method 42 includes the step 48 of placing a preformed porous and fibrous reinforcement mat 16 directly on top of the skin 12. It is preferred that one portion of reinforcement mat 16 rests directly on top of skin 12, while another portion of reinforcement mat 16 is separated from the skin 12 to provide one or more void regions between the skin 12 and reinforcement mat 16. The step 48 of locating the reinforcement mat 16 and skin 12 onto the lower die 38 of tool 34 is illustrated in FIG. 6. Fibrous reinforcement mat 16 is soft, yet preferably of a preformed configuration such that it rests directly on top of skin 12 and maintains its preformed configuration such that the desired void region remains between the skin 12 and reinforcement mat 16.

Next, according to step 50 of trim manufacture method 42, liquid urethane foam is injected into the lower die 38 of the foam molding tool 34. The liquid urethane foam may be applied to the lower die 38 with the same pump style, high pressure foam dispenser 40 as is illustrated in FIG. 4. The urethane foam is dispensed directly on top of the fiber reinforcement mat 16 such that the liquid foam penetrates into and through reinforcement mat 16 and into the void region between skin 12 and reinforcement mat 16. The porous reinforcement mat 16 has openings that allow the liquid urethane to penetrate into and through the mat 16 and thereby pass into the void region between reinforcement mat 16 and skin 12. The liquid urethane also penetrates between the skin 12 and the portion of the reinforcement mat 16 that rests on top of skin 12. This provides for a foam separation layer between all portions of skin 12 and reinforcement mat 16.

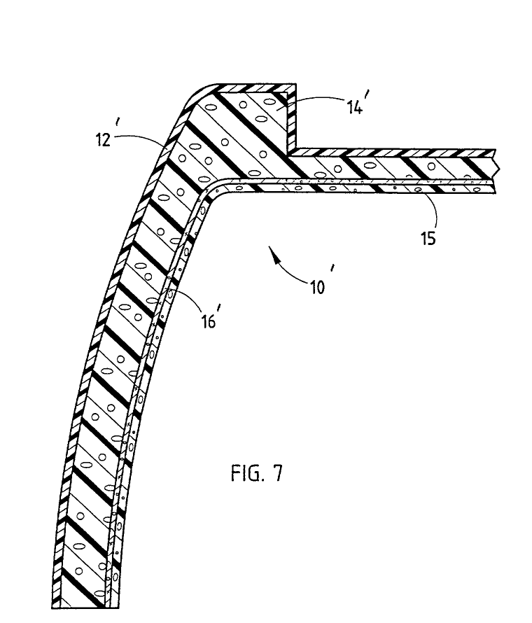

Immediately following application of the liquid foam, the molding tool 34 is closed according to step 52 to allow the foam to expand and cure such that the foam binds to both the skin 12 and reinforcement mat 16. The curing step 52 preferably occurs at a temperature in the range of 90° to 150° F., and for a time period in the range of 30 to 120 seconds. It should be appreciated that the skin 12 and the reinforcement mat 16 are both bonded to the foam to form an integrated vehicle interior trim panel in a one-step molding process. Upon completion of the curing step, the tool is opened and the interior trim panel is demolded and removed pursuant to step 54. The interior trim panel may further be trimmed as is known in the art to provide a final finished interior trim product as shown in FIG. 7.

Referring to FIG. 7, the interior trim 10′ has the fibrous reinforcement mat 16′ integrally formed within the semi-rigid polyurethane foam such that the reinforcement mat 16′ is bonded to foam layer 14′ on one side and a second foam layer 15 on the back side. This can be achieved in accordance with method 42 by allowing a substantial amount of the liquid foam to penetrate through reinforcement mat 16′ to expand and cure between mat 16′ and skin 12′ and bond to mat 16′, and leaving a remaining portion of the liquid foam on the back side of reinforcement mat 16′ to likewise expand and cure and bond to the reinforcement mat 16′. This provides for a one-step method of manufacturing vehicle interior trim with a fiber reinforced backing of rigid support integrally formed within the molded foam and bonded thereto.

The trim manufacturing methods 20 and 42 of the present invention provide a one-step molding process in which the foam-forming material penetrates through the fibrous reinforcement mat 16 and expands to fill all void regions within the molding tool, to prevent the creation of defects. In addition, the distance between the skin 12 and fibrous reinforcement mat 16 can be varied to change the structural feel of the final trim product. For example, a reduced foam thickness will increase the percentage of reinforcement and provide higher structural rigidity, whereas a thicker layer of foam will be softer on the trim surface. Further, it is preferred that the foam free rise density be within a range of four to six pounds-per-cubic foot (4-6 pcf), and the cured foam-forming material exhibit a final molded density of less than 15 pcf.

Accordingly, the trim 10 and 10′ and their manufacturing methods 20 and 42 of the present invention advantageously provide for an integrated vehicle interior trim member made in a one-step manufacturing process that applies liquid urethane foam that binds a reinforcement mat to the finished skin in a manner that does not require the use of adhesives and which is less susceptible to creating defects in the final trim product.

It will become apparent to those skilled in the art that various modifications to the preferred embodiment of the present invention can be made without departing from the spirit and scope thereof as defined by the appended claims.

What is claimed is:

1. An integrated interior trim piece for a vehicle comprising:
an upholstery skin material;
a substrate; and
a molded foam material extending between said upholstery skin material and said substrate, for bonding said upholstery skin material to said substrate.

2. The interior trim piece as defined in claim 1, wherein said substrate comprises a porous material having openings therein, wherein said moldable foam material penetrates said openings and bonds to said porous material through said openings.

3. The interior trim piece as defined in claim 2, wherein said substrate comprises a fiber reinforced mat.

4. The interior trim piece as defined in claim 3, wherein said fiber reinforced mat comprises fiberglass.

5. The interior trim piece as defined in claim 1, wherein said molded foam material is formed on opposite sides of said substrate.

6. An interior trim piece for a vehicle comprising:
an upholstery skin material;
a molded foam layer bonded to said upholstery skin material; and
a substrate integrally formed within said foam layer, wherein said foam layer forms a bond between said substrate and said upholstery skin material.

7. The interior trim as defined in claim 6, wherein said substrate comprises a porous fibrous material having openings therein, wherein molded foam penetrates said openings to form a bond to said porous fibrous material through said openings.

8. The interior trim piece as defined in claim 7, wherein said substrate comprises a fiber reinforced mat.

9. The interior trim piece as defined in claim 7, wherein said fiber reinforced mat comprises fiberglass.

10. The interior trim piece as defined in claim 6, wherein said foam layer comprises polyurethane.

11. A method of manufacturing interior trim for a vehicle, comprising the steps of:
locating a skin material on one die part of a molding tool;
locating a fibrous reinforcement mat having openings therein on a second die part of said molding tool;
applying a moldable foam-forming material over at least a portion of said skin material and between said skin material and said fibrous reinforcement mat, such that said foam-forming material penetrates said openings in said fibrous reinforcement mat;
curing said moldable foam-forming material so that said foam-forming material expands and binds to both said skin material and said fibrous reinforcement mat to form a trim piece; and
removing the trim piece from said molding tool.

12. The method as defined in claim 11, wherein said step of applying said moldable foam-forming material comprises dispensing a liquid urethane foam between said skin material and said fibrous reinforcement mat.

13. The method as defined in claim 11, further comprising the step of performing said method in a reaction-injection molded delivery system.

14. The method as defined in claim 11, further comprising the step of forming a slush molded PVC skin as said skin material.

15. The method as defined in claim 11, further comprising the step of providing a fiberglass mat as said fibrous reinforcement mat.

16. The method as defined in claim 11, wherein said step of curing includes expanding said foam-forming material to provide expanded foam with a varying thickness.

17. The method as defined in claim 11, wherein said step of curing is provided for a period of time in the range of 30 seconds to 120 seconds.

18. The method as defined in claim 11, wherein said step of curing includes heating said molding tool to a temperature in the range of 90° to 150° F.

19. The method as defined in claim 11, wherein said moldable foam-forming material has a final molded density of less than 15 pcf.

20. A one-step method of manufacturing vehicle interior trim having a finish face, a structural reinforcement, and an interstitial layer of foam, comprising the steps of:
locating a skin material on one die part of a two-part die molding tool;
placing a fibrous reinforcement mat having openings therein on a second die part of said two-part die molding tool;
applying a moldable urethane foam material over at least a portion of said skin material and between said skin material and said fibrous reinforcement mat;
closing said two-part die molding tool;
curing said urethane foam material so that said foam expands and binds to both said skin material and said reinforcement mat, such that said foam-forming material penetrates said openings in said fibrous reinforcement mat; and
removing said cured interior trim from said molding tool.

21. A method of manufacturing interior trim for a vehicle, comprising the steps of:
locating a skin material in a molding tool;
locating a porous fibrous reinforcement mat in said molding tool;
applying a moldable, foam-forming material between said skin material and said fibrous reinforcement mat;
curing said moldable, foam-forming material so that said moldable, foam-forming material expands and binds to said skin material and said reinforcement mat, such that said foam-forming material penetrates openings in said porous fibrous reinforcement mat; and
removing the cured interior trim from said molding tool.

22. The method as defined in claim 21, wherein said step of locating said skin material and said fibrous reinforcement mat in said molding tool further comprises locating said skin material on one die part of said molding tool and placing said fibrous reinforcement mat on a second die part of said molding tool.

23. The method as defined in claim 21, wherein said step of curing includes a step of closing said molding tool.

24. The method as defined in claim 21, wherein said step of locating said porous fibrous reinforcement mat in said molding tool further comprises locating said porous fibrous reinforcement mat on top of said skin material such that a portion of said reinforcement mat rests on top of said skin material.

25. The method as defined in claim 24, wherein said step of locating said porous fibrous reinforcement mat further comprises locating said reinforcement mat such that another portion of said reinforcement mat is separate in space from said skin material.

26. The method as defined in claim 25, wherein said applied foam-forming material penetrates said openings in said porous fibrous reinforcement mat to consume volume between said another portion of the reinforcement mat and said skin material.

27. The method as defined in claim 26 further comprising the step of closing said molding tool subsequent to said step of applying said moldable foam-forming material.

28. The method as defined in claim 21, wherein said moldable foam-forming material is applied and cured on both a front side and a back side of said reinforcement mat.

29. A method of manufacturing vehicle interior trim, comprising the steps of:
locating a skin material on one die part of a molding tool;
locating a fibrous reinforcement mat having openings therein on said skin material such that said reinforcement mat rests on top of said skin material;
applying a moldable, foam-forming material to said skin material and said fibrous reinforcement mat, such that said foam-forming material penetrates said fibrous reinforcement mat; and
curing said moldable, foam-forming material so that said molded foam material binds to both said skin and said fibrous reinforcement mat to form an interior trim piece.

30. The method as defined in claim 29, wherein said step of locating said fibrous reinforcement mat further comprises disposing said fibrous reinforcement mat on top of said skin material such that one portion of said reinforcement mat rests on top of said skin material and another portion of said fibrous reinforcement mat is distanced from the skin material.

31. The method as defined in claim 30, wherein said step of locating said fibrous reinforcement mat further includes the step of preforming said fibrous reinforcement mat into a predetermined configuration.

32. The method as defined in 29 further comprising the step of removing said trim piece from said molding tool.

33. The method as defined in claim 29, wherein said step of applying a moldable foam-forming material further includes applying said foam-forming material on opposite sides of said fibrous reinforcement mat.
